(19) United States
(12) Patent Application Publication
(10) Pub. No.: US 2005/0102183 A1
(43) Pub. Date: May 12, 2005

(54) Monitoring system and method based on information prior to the point of sale

(75) Inventors: Timothy Patrick Kelliher, Scotia, NY (US); Mark Lewis Grabb, Burnt Hills, NY (US); Douglas H. Marman, Ridgefield, WA (US); Peter Henry Tu, Schenectady, NY (US); Jens Rittscher, Schenectady, NY (US)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 10/706,643

(22) Filed: Nov. 12, 2003

(51) Int. Cl. G06F 17/60

(52) U.S. Cl. 705/16

(57) ABSTRACT

A monitoring system and method based on information about a shopper's location and behavior prior to approaching the check-out counter improves detection of fraud. A tracking mechanism tracks a shopper and merchandise as the shopper is shopping and generates a list of currently acquired items. At the point of sale, the list of currently acquired items is compared to the list of purchased items and any discrepancies are provided.

### BACKGROUND

The present disclosure generally relates to retail security. In particular, the present disclosure relates to a monitoring system and method based on information prior to the point of sale.

To operate a successful retail business, you have to create a secure environment to avoid retail shrinkage. Retail shrinkage is a costly problem. A significant portion of the loss due to retail shrinkage occurs through shoplifting and sweethearting. Sweethearting is a collusion between the cashier and shopper to defraud the store by ringing up a lower cost item. Many attempts have been made to address shoplifting and sweethearting, most notably closed-circuit TV, store detectives, and tagged inventory. However, conventional approaches rely on an operator to constantly observe transactions. There is a need for a way to automatically capture information about a shopper's location and behavior prior to approaching the check-out counter, so that shoplifting and sweethearting at the point of sale can be detected more efficiently and effectively.

### SUMMARY

The present disclosure is directed to a monitoring system and method that satisfy these and other needs.

One aspect is a monitoring system comprising a tracking mechanism and a processor. The tracking mechanism tracks a shopper and merchandise as the shopper is shopping and generates a list of currently acquired items. The processor compares the list of currently acquired items to a list of purchased items that are generated at a point of sale and provides any discrepancies. In one embodiment, the tracking mechanism comprises an object tracking component, a shopper tracking component, and a behavior recognition component. The object tracking component tracks the merchandise. The shopper tracking component tracks shoppers and other people. The behavior recognition component analyzes tracking information from the object tracking component and the shopper tracking component to determine acquisition events. In another embodiment, the monitoring system further comprises a storage device. The storage device stores the list of currently acquired items and a history.

Another aspect is a monitoring method. Location information and behavior information about a shopper as the shopper is shopping is analyzed to generate a list of acquired items. A list of purchased items is generated at a point of sale. The list of acquired items is compared to the list of purchased items. Any discrepancies between the list of acquired items and the list of purchased items is provided. In one embodiment, the list of acquired items and the location information having known merchandise locations is compared and any discrepancies are provided. In another embodiment the location information and the behavior information about the shopper is gathered. In another embodiment, a history of location information, behavior information, and acquired items is stored.

Another aspect is a computer readable medium having instructions for performing a monitoring method. Tracking information about at least one shopper is gathered substantially continuously from a point of entry into a shop. A list of acquired items for the shopper is generated. At a point of sale, scanning is performed that generates a list of purchased items for the shopper. The list of acquired items and the list of purchased items are compared and any discrepancies are provided. In one embodiment, A history for the shopper is stored. In another embodiment, information is gathered about the shopper over a plurality of shopping trips. In another embodiment, generating the list of acquired items for the shopper is performed by analyzing the tracking information to recognize acquisition events.

### BRIEF DESCRIPTION OF THE DRAWINGS

These and other features, aspects, and advantages of the present disclosure will become better understood with reference to the following description, appended claims, and drawings where:

FIG. 1 is an example monitoring system; and

FIG. 2 is an example monitoring method.

### DETAILED DESCRIPTION

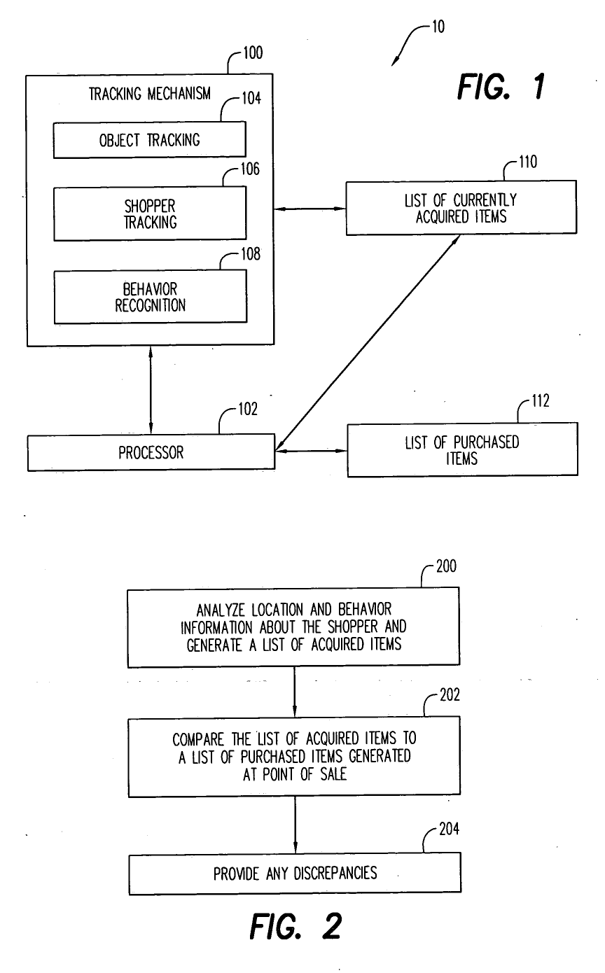

FIG. 1 shows an example monitoring system 10 with a tracking mechanism 100 and a processor 102. Monitoring system 10 may be part of a larger integrated retail system together with a video system, an access control system, and the like.

Tracking mechanism 100 is any kind of mechanism, such as video surveillance systems, RFID systems, or combinations of systems. Tracking mechanism 100 has an object tracking component 104, a shopper tracking component 106, and a behavior recognition component 108. Object tracking component 104 tracks merchandise and other objects. Examples of object tracking component 104 include RFID systems and video surveillance systems. Shopper tracking component 106 tracks shoppers and other people. One example of shopper tracking component 106 is a video surveillance system. Behavior recognition component 108 analyzes tracking information to determine acquisition events and other events. Behavior recognition component 108 reduces a shopper's actions to a set of primitives used to recognize events. Some examples of events are motion towards a piece of merchandise, stopping at a certain location, picking up merchandise, putting merchandise in a cart, opening merchandise and taking something out of it, putting down merchandise, and the like. In some embodiments, tracking mechanism 100 includes a storage device, such as a database for storing tracking information and other data for monitoring system 10.

A list of currently acquired items 110 is generated by tracking mechanism 100. As a shopper is shopping, list of currently acquired items 110 is generated, stored, and updated based on acquisition events. Alerts may also be created automatically based on list of currently acquired items 110 to people, such as those monitoring closed circuit TV or managers.

Processor 102 is any type of processor, such as a personal computer (PC) a server, bar scanning system, a cash register or combination of devices. Processor 102 generates a list of purchased items 112 at the point of sale or checkout.

List of purchased items 112 is compared to list of currently acquired items 110 and any discrepancies are provided. Discrepancies include things that the shopper paid for but were not detected as acquired items, things that the shopper acquired but did not purchase, and things acquired but not detected as purchased. Other categories are also contemplated. Some retailers are hesitant to directly approach customers with what amounts to an accusation of theft, so sometimes additional analysis is performed or additional information is gathered over a plurality of shopping trips. If a retailer learns that certain people are habitually in the category of having things they picked up and did not pay for, they may be invited to not to shop at the store anymore. Also, employees may be monitored for sweethearting.

FIG. 2 shows an example monitoring method. In step 200, monitoring system 10 analyzes location and behavior information about the shopper and generates a list of acquired items. In step 202, monitoring system 10 compares the list of acquired items to the list of purchased items generated at the point of sale. In step 204, any discrepancies are provided.

The technical effect is automatically capturing information about a shopper's location and behavior prior to approaching the check-out counter, so that shoplifting and sweethearting at the point of sale can be detected more efficiently and effectively than conventional systems and methods.

In some embodiments, location and behavior information is gathered by parts of monitoring system 10, such as an RFID system or a video surveillance system as the shopper is shopping. This information may be gathered periodically, substantially continuously, and cumulatively. In some embodiments, a history of location information, behavior information, and acquired items is created. The history for each shopper is created and maintained for use during this shopping trip, future use, or any other use. For example, it would be suspicious if the shopper never walked down the isle where light bulbs are located, but a light bulb is detected at the point of sale while more expensive merchandise was determined to be acquired by the shopper earlier.

It is to be understood that the above description is intended to be illustrative and not restrictive. Many other embodiments will be apparent to those of skill in the art upon reviewing the above description, such as adaptations of the present disclosure to access control systems, or other kinds of security systems. Behaviors other than shoplifting and sweethearting may be detected, such as vandalism or theft. Various designs using hardware, software, and firmware are contemplated by the present disclosure, even though some minor elements would need to change to better support the environments common to such systems and methods. The present disclosure has applicability to fields outside retail shops, such as airports, offices, and other kinds of facilities needing security. Therefore, the scope of the present disclosure should be determined with reference to the appended claims, along with the full scope of equivalents to which such claims are entitled.

1. A monitoring system comprising:
a tracking mechanism for tracking a shopper and merchandise as said shopper is shopping and for generating a list of currently acquired items; and
a processor for comparing said list of currently acquired items to a list of purchased items generated at a point of sale and for providing any discrepancies.

2. The system according to claim 1, where said tracking mechanism comprises:
an object tracking component to track said merchandise;
a shopper tracking component to track said shopper; and
a behavior recognition component to analyze tracking information from said object tracking component and said shopper tracking component to determine acquisition events.

3. The system according to claim 1, further comprising:
a storage device for storing said list of currently acquired items.

4. The system according to claim 3, wherein said storage device also stores a history.

5. A monitoring method comprising:
analyzing location information and behavior information about a shopper as said shopper is shopping to generate a list of acquired items;
generating a list of purchased items at a point of sale;
comparing said list of acquired items to said list of purchased items; and
providing any discrepancies between said list of acquired items and said list of purchased items.

6. The method according to claim 5, further comprising:
comparing said list of acquired items and said location information having known merchandise locations and providing any discrepancies.

7. The method according to claim 5, further comprising:
gathering said location information and said behavior information about said shopper.

8. The method according to claim 5, further comprising:
storing a history of location information, behavior information, and acquired items.

9. A computer readable medium having instructions for performing a monitoring method, said method comprising:
gathering tracking information about at least one shopper substantially continuously from a point of entry into a shop;
generating a list of acquired items for said shopper;
scanning at a point of sale to generate a list of purchased items for said at least one shopper; and
comparing said list of acquired items and said list of purchased items and providing any discrepancies.

10. The computer readable medium according to claim 9, further comprising:
storing a history for said at least one shopper.

11. The computer readable medium according to claim 9, further comprising:
gathering information about said at least one shopper over a plurality of shopping trips.

12. The computer readable medium according to claim 9, wherein generating said list of acquired items for said shopper is performed by analyzing said tracking information to recognize acquisition events.
